(19) United States
(12) Patent Application Publication
(10) Pub. No.: US 2025/0337172 A1
(43) Pub. Date: Oct. 30, 2025

(54) BASE STATION ANTENNAS HAVING A SUPPLEMENTAL FREQUENCY SELECTIVE SURFACE STRUCTURE

(71) Applicant: Outdoor Wireless Networks LLC, Richardson, TX (US)

(72) Inventors: Bo Huang, Suzhou (CN); YueMin Li, Suzhou (CN); Jian Liu, Suzhou (CN); Yunzhe Li, Suzhou (CN); Jian Zhang, Suzhou (CN); Jiajia Ni, Suzhou (CN); Bo Wu, Allen, TX (US)

(21) Appl. No.: 19/085,193

(22) Filed: Mar. 20, 2025

(30) Foreign Application Priority Data
Apr. 30, 2024 (CN) 202410535636.X

(51) Int. Cl. H01Q 15/00; H01Q 1/24; H01Q 5/22; H04B 7/04

(52) U.S. Cl. CPC H01Q 15/0013; H01Q 1/246; H01Q 5/22; H04B 7/04013

(57) ABSTRACT

Base station antennas include a supplemental FSS structure with a metal grid layer and a printed circuit board layer stacked in a front to back direction and aligned in a longitudinal direction. The supplemental FSS structure resides between, in a longitudinal direction, a first FSS layer and a primary reflector. The supplemental FSS structure reflects and/or blocks RF energy from one of low band or mid-band radiating elements and passes RF energy from an array of mMIMO radiating elements in a higher frequency band than the low and mid-band radiating elements.

### RELATED APPLICATION

The present application claims the benefit of and priority to Chinese Patent Application Number 202410535636.X filed Apr. 30, 2024, the contents of which are hereby incorporated by reference as if recited in full herein.

### BACKGROUND

The present invention generally relates to radio communications and, more particularly, to base station antennas for cellular communications systems.

Cellular communications systems are well known in the art. In a cellular communications system, a geographic area is divided into a series of regions that are referred to as “cells” which are served by respective base stations. The base station may include one or more antennas that are configured to provide two-way radio frequency (“RF”) communications with mobile subscribers that are within the cell served by the base station. In many cases, each cell is divided into “sectors.” In one common configuration, a hexagonally shaped cell is divided into three 120° sectors in the azimuth plane, and each sector is served by one or more base station antennas that have an azimuth Half Power Beamwidth (HPBW) of approximately 65°. Typically, the base station antennas are mounted on a tower or other raised structure, with the radiation patterns (also referred to herein as “antenna beams”) that are generated by the base station antennas directed outwardly. Base station antennas are often implemented as linear or planar phased arrays of radiating elements.

In order to accommodate the increasing volume of cellular communications, cellular operators have added cellular service in a variety of new frequency bands. In order to increase capacity without further increasing the number of base station antennas, multi-band base station antennas have been introduced which include multiple linear arrays of radiating elements. Additionally, base station antennas are now being deployed that include “beamforming” arrays that include multiple columns of radiating elements. The radios for these beamforming arrays may be integrated into the antenna so that the antenna may perform active beamforming (i.e., the shapes of the antenna beams generated by the antenna may be adaptively changed to improve the performance of the antenna). These beamforming arrays typically operate in higher frequency bands, such as various portions of the 3.3-5.8 GHz frequency band. Antennas having integrated radios that can adjust the amplitude and/or phase of the sub-components of an RF signal that are transmitted through individual radiating elements or small groups thereof are referred to as “active antennas.” Active antennas can generate narrowed beamwidth, high gain, antenna beams and can steer the generated antenna beams in different directions by changing the amplitudes and/or phases of the sub-components of RF signals that are transmitted through the antenna.

With the development of wireless communication technology, an integrated base station antenna including a passive module and an active antenna module with an active antenna has emerged. The passive module may include one or more passive arrays of radiating elements that are configured to generate relatively static antenna beams, such as antenna beams that are configured to cover a 120-degree sector (in the azimuth plane) of a base station antenna. The passive arrays may comprise arrays that operate under second generation (2G), third generation (3G) or fourth generation (4G) cellular standards. These passive arrays are not configured to perform active beamforming operations, although they typically have remote electronic tilt (RET) capabilities which allows the shape of the antenna beam to be changed via electromechanical means in order to change the coverage area of the antenna beam. The active antenna module may include one or more arrays of radiating elements that operate under fifth generation (or later) cellular standards. These arrays typically have individual amplitude and phase control over subsets of the radiating elements therein and perform active beamforming.

FIGS. 1 and 2 illustrate an example of a prior art base station antenna 10 that includes a pair of beamforming arrays and associated beamforming radios. The base station antenna 10 is typically mounted with the longitudinal axis L of the antenna 10 extending along a vertical axis (e.g., the longitudinal axis L may be generally perpendicular to a plane defined by the horizon) when the antenna 10 is mounted for normal operation. The front surface of the antenna 10 is mounted opposite the tower or other mounting structure, pointing toward the coverage area for the antenna 10. The antenna 10 includes a radome 11 and a top end cap 20. The antenna 10 also includes a bottom end cap 30 which includes a plurality of connectors 40 mounted therein. As shown, the radome 11, top cap 20 and bottom cap 30 define an external housing 10h for the antenna 10. An antenna assembly is contained within the housing 10h.

FIG. 2 illustrates that the antenna 10 can include one or more radios 50 that are mounted to the housing 10h. Further details of example conventional base station antennas can be found in co-pending WO2019/236203 and WO2020/072880, the contents of which are hereby incorporated by reference as if recited in full herein.

Base station antennas that include active antenna units with a radio and a mMIMO array of radiating elements that reside behind a rear of the base station antenna have also been disclosed. See, U.S. Pat. No. 11,482,774, the contents of which are also hereby incorporated by reference as if recited in full herein.

### SUMMARY

Embodiments of the present invention are directed to base station antennas with a supplemental frequency selective surface (FSS) structure that resides between (in a longitudinal direction) a first frequency selective surface (FSS) and a primary reflector. The supplemental FSS structure has a shorter length (in the longitudinal direction) than the first FSS and the primary reflector.

Low band and mid-band radiating elements can be arranged to project forward of the supplemental FSS structure with feed boards for at least some of the radiating elements coupled to the supplemental FSS structure.

The supplemental FSS structure can be parallel to the primary reflector and the first FSS, typically aligned with one or both in a front-to-back direction of the base station antenna to reside at least partially in a common longitudinally extending plane.

The supplemental FSS structure can be provided as a grid layer and a cooperating printed circuit board layer, stacked in a front to back direction. Alternatively, the supplemental FSS structure can be provided as a grid layer which may cooperate with a portion of the first FSS so that the grid layer overlaps the first FSS layer and can reside in front thereof in the front to back direction.

The grid layer can reside in front of the PCB FSS layer and/or the first FSS.

The supplemental FSS structure can reflect or block low band and mid-band signal from respective low band and mid-band radiating elements and pass a higher band signal from higher band radiating elements behind the supplemental FSS.

The supplemental FSS structure can be configured to allow high band radiating elements to propagate electromagnetic waves therethrough and reflect lower band signal from lower band radiating elements in front of the supplemental FSS structure.

The supplemental FSS structure can have a metal grid layer with feed board apertures. The feed board apertures and respective feed boards can be mounted to the metal grid layer to extend across the respective feed board apertures. One or more feed stalks can be mounted to project forward and rearward of the feed board and the metal grid layer.

The supplemental FSS structure can be provided with a metal grid layer with a respective array of unit cells and feed stalks that project forward of the metal grid layer.

The supplemental FSS structure can include a printed circuit board with an array of unit cells that can be defined by conductive patches. The array or unit cells can be provided in a pattern that is different from a pattern of the array of unit cells of the metal grid layer.

The printed circuit board can be configured to block or reflect low band and mid band signal from respective low band and mid-band radiating elements while the metal grid layer can be configured to block and/or reflect low band and mid-band signal from respective low-band and mid-band radiating elements.

Embodiments of the present invention are directed to a base station antenna that includes: a first frequency selective surface (FSS); a primary reflector; and a supplemental frequency selective surface (FSS) structure residing between the first FSS and the primary reflector in a longitudinal direction.

The supplemental FSS structure can include a metal grid layer with an array of unit cells and a printed circuit board layer with an array of unit cells. The metal grid layer and the printed circuit board layer can be aligned to reside in a substantially common footprint in the longitudinal direction and stacked in a front-to-back direction of the base station antenna.

The metal grid layer can reside in front of the printed circuit board layer.

The base station antenna can further include a pair of laterally spaced apart and longitudinally extending rails. The supplemental FSS structure can extends laterally between the rails and can be attached to the rails.

The supplemental FSS structure has a length, the primary reflector has a length and the first FSS has a length, all in the longitudinal direction of the base station antenna. The length of at least one layer of the supplemental FSS can be in a range of 10-30% of the length of the first FSS and/or the primary reflector.

The supplemental FSS structure can be parallel to the first FSS and the primary reflector.

At least part of the supplemental FSS structure can reside in a common plane as the first FSS.

At least part of the supplemental FSS structure can reside in a plane that is in front of the first FSS.

The supplemental FSS structure can include a metal grid layer with an array of unit cells that resides in a plane in front of a plane of the first FSS and can have a longitudinal extent that resides only along a portion of the first FSS or that is configured to not overlap with the first FSS.

The base station antenna can further include a feed board coupled to the metal grid layer and the feed board can be configured to replicate at least part of a unit cell shape of a unit cell of the array of unit cells.

The supplemental FSS structure can include a metal grid layer that has at least one feed board aperture and an array of unit cells. The feed board can extend across and overlap a portion of a plurality of unit cells of the array of unit cells that surround the feed board aperture.

The feed board can have metal shapes that replicate at least part of a shape of a unit cell structure of one or more of the plurality of unit cells and the metal shapes can overlap at least some of the plurality of unit cells.

The base station antenna can further include a first linear array of first radiating elements and a second linear array of first radiating elements. A single one of the first radiating elements of the first linear array of first radiating elements and a single one of the first radiating elements of the second linear array of radiating elements can project forward from the supplemental FSS structure.

The base station antenna can further include a plurality of columns of second radiating elements that are laterally spaced apart. Only two rows of each of the plurality of columns of second radiating elements can project forward from the supplemental FSS structure.

The base station antenna can also include a bracket that extends laterally between a pair of longitudinally extending rails and the bracket can be attached to a bottom portion of the supplemental FSS structure and to the primary reflector.

The bracket can have a U-shape with the arms of the U-shape facing downward over the primary reflector.

A closed laterally extending end of the U-shape can be attached to the supplemental FSS structure and the first FSS can be attached to a top portion of the supplemental FSS structure.

The metal grid layer has side walls that can angle outward in a forward direction from a primary planar body thereof, and the printed circuit board layer of the supplemental FSS structure can terminate laterally inward of the side walls of the metal grid layer.

The side walls can have an array of unit cells arranged in a repeating pattern along a length of the supplemental FSS structure.

The array of unit cells of the metal grid layer can be arranged in a first pattern that extends across at least a major portion of a lateral dimension of the base station antenna behind a first and second linear arrays of first radiating elements, behind multiple columns of second radiating elements and in front of a multiple-column array of third radiating elements.

The supplemental FSS structure can reflect and/or block energy in a first operating frequency band of a first radiating element of the base station antenna and in a second operating frequency band of a second radiating element of the base station antenna. The second frequency band can include frequencies above the first frequency band, and the supplemental FSS structure can allow energy from a mMIMO array of radiating elements in a third operating frequency band to propagate therethrough. The third operating frequency band can include frequencies above the second frequency band. At least some of the mMIMO array of radiating elements can be positioned behind the supplemental FSS structure.

The base station antenna can include an active antenna unit positioned behind a rear of a housing enclosing the first FSS, the supplemental FSS structure and the primary reflector.

The supplemental FSS structure can be configured to allow RF energy in at least part of a 3.2-4.1 GHz frequency band to propagate therethrough.

The base station antenna can further include a plurality of feed boards coupled to the supplemental FSS structure. At least some of the plurality of feed boards can have a lattice body with apertures surrounded by linear segments defining at least first and second conductive signal traces. The first and second conductive signal traces can extend downward over the primary reflector.

At least some of the linear segments of the feed boards can align with metal linear segments of the metal grid layer.

At least some of the linear segments of the feed boards can extend downward over the primary reflector.

The first FSS can terminate above the supplemental FSS structure.

The metal grid layer can be configured to block and/or reflect RF energy from mid-band radiating elements, and the printed circuit board layer can be configured to block and/or reflect RF energy from low-band radiating elements.

The metal grid layer can be configured to block and/or reflect RF energy from low-band radiating elements and the printed circuit board layer can be configured to block and/or reflect RF energy from mid-band radiating elements.

The metal grid layer can be configured to block and/or reflect RF energy from low-band and mid-band radiating elements and the printed circuit board layer can be configured to block and/or reflect RF energy from low-band and mid-band radiating elements.

Yet other aspects of the present invention are directed to a base station antenna that includes: a reflector; a first frequency selective surface (FSS); an array of first frequency band radiating elements that are all coupled to a first radio frequency (RF) input, where a first subset of the first frequency band radiating elements overlap the reflector in a forward direction that is perpendicular to a plane defined by a major surface of the reflector and a second subset of the first frequency band radiating elements overlap the first FSS in the forward direction; and a supplemental frequency selective surface (FSS) structure that overlaps the first FSS and at least one of the first frequency band radiating elements in the second subset of the first frequency band radiating elements in the forward direction but does not overlap all of the first frequency band radiating elements in the second subset of the first frequency band radiating elements in the forward direction.

The base station antenna can further include comprising an array of second frequency band radiating elements that are all coupled to a second RF input, where a first subset of the second frequency band radiating elements overlap the reflector in the forward direction and a second subset of the second frequency band radiating elements overlap both the first FSS and the supplemental FSS in the forward direction. The second frequency band can encompass higher frequencies than the first frequency band.

The supplemental FSS can be configured to reflect RF energy in an operating frequency band of the array of second frequency band radiating elements.

None of the second frequency band radiating elements overlap the first FSS.

None of the second frequency band elements project forward from the first FSS and only some of the second frequency band radiating elements project forward from the supplemental FSS.

It should be noted that various aspects of the present disclosure described for one embodiment may be included in other different embodiments, even though specific description is not made for the other different embodiments. In other words, all the embodiments and/or features of any embodiment may be combined in any manner and/or combination, as long as they are not contradictory to each other.

### BRIEF DESCRIPTION OF THE DRAWINGS

FIG. 1 is a perspective view of a prior art base station antenna.

FIG. 2 is a back view of another prior art base station antenna.

FIG. 3 is a back perspective view of an example base station antenna coupled to an active antenna module according to embodiments of the present invention.

FIG. 4 is a front view of a portion of a base station antenna.

FIG. 5A is a front view of a portion of a base station antenna comprising a supplemental FSS structure according to embodiments of the present invention.

FIG. 5B is a side view of a portion of the base station antenna shown in FIG. 5A with certain components omitted to show the supplemental FSS structure in relation to a first FSS according to embodiments of the present invention.

FIG. 5C is a side schematic view of the portion of the base station antenna shown in FIG. 5B but illustrating a different configuration of the supplemental FSS structure and the first FSS according to embodiments of the present invention.

FIG. 6 is a back view of the portion of the base station antenna shown in FIG. 4.

FIG. 7 is a back view of the portion of the base station antenna shown in FIG. 5A according to embodiments of the present invention.

FIG. 8 is a simplified lateral schematic section view of a portion of a base station antenna showing the supplemental FSS structure in front of components of an active antenna module according to embodiments of the present invention.

FIG. 9 is a simplified schematic side view illustration of a portion of a base station antenna showing the supplemental FSS structure in front of an active antenna module according to embodiments of the present invention.

FIG. 10 is a front view of an example array of radiating elements for an active antenna module according to embodiments of the present invention.

FIG. 11 is a simplified schematic exploded view of a portion of a base station antenna illustrating example unit cell shapes of the supplemental FSS structure according to embodiments of the present invention.

FIG. 12A is an enlarged view of a portion of an example grid layer of the supplemental FSS structure according to embodiments of the present invention.

FIG. 12B is an enlarged view of an example feed board with a feed stalk according to embodiments of the present invention.

FIG. 12C is an assembled view of the portion of the grid layer and feed board shown in FIGS. 12A and 12B, respectively, according to embodiments of the present invention.

FIG. 13 is a rear view of a portion of a grid layer comprising a radiating element and feed board according to embodiments of the present invention.

FIG. 14 is a rear view of another embodiment of a portion of a grid layer comprising a radiating element according to embodiments of the present invention.

FIG. 15 is a rear view of another embodiment of a portion of a grid layer comprising a radiating element according to embodiments of the present invention.

FIG. 16 is a front view of the grid layer and feed board shown in FIG. 15 according to embodiments of the present invention.

FIG. 17A is an enlarged, front perspective view of another embodiment of a portion of a grid layer comprising a feed board with a rear conductive layer and radiating element according to embodiments of the present invention.

FIG. 17B is an enlarged, front perspective view of another embodiment of a portion of a grid layer comprising a feed board with front conductive layer and radiating element according to embodiments of the present invention.

FIG. 18 is a side perspective view of an example feed board.

FIG. 19 is an enlarged rear view of a portion of the feed board and grid layer with a feed stalk according to embodiments of the present invention.

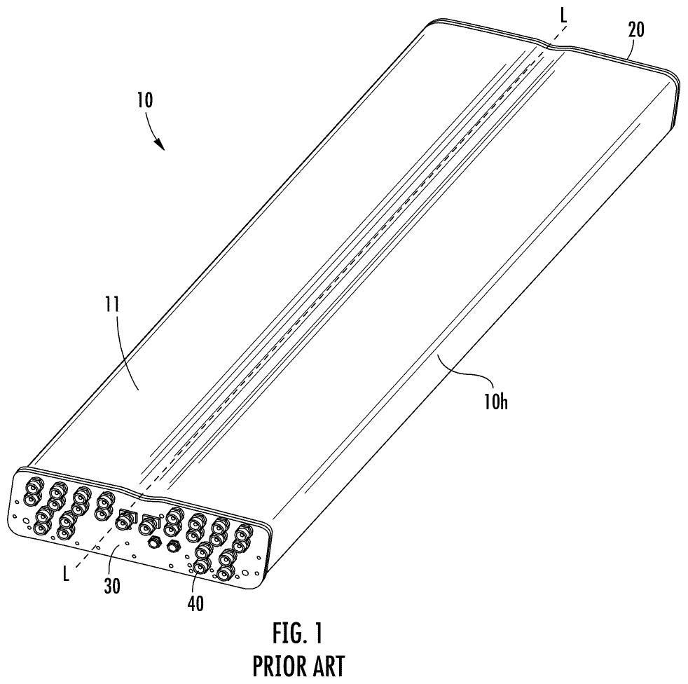

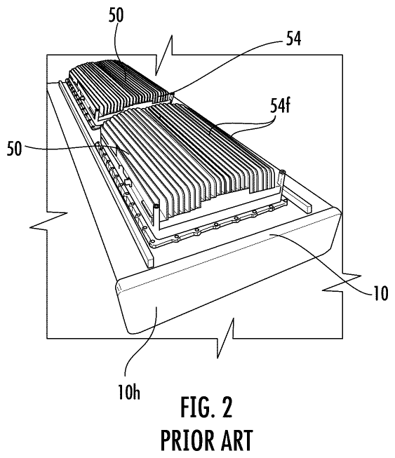

### DETAILED DESCRIPTION

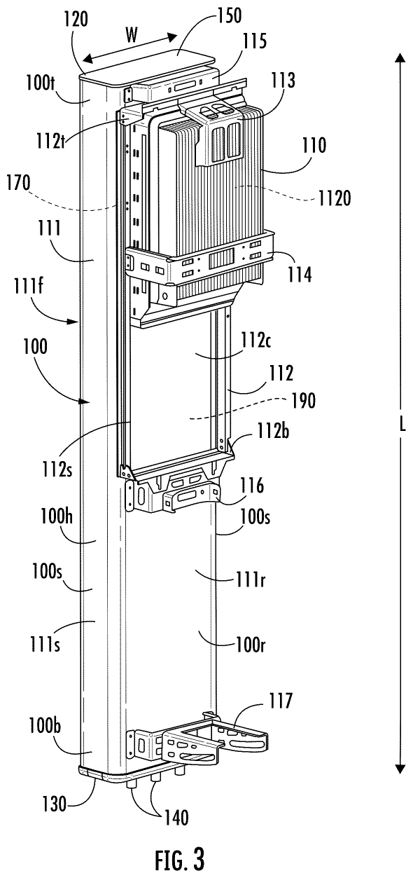

FIG. 3 illustrates a base station antenna 100 according to certain embodiments of the present invention. In the description that follows, the base station antenna 100 will be described using terms that assume that the base station antenna 100 is mounted for use on a tower, pole or other mounting structure with the longitudinal axis L of the base station antenna 100 extending along a vertical axis and the front of the base station antenna 100 mounted opposite the tower, pole or other mounting structure pointing toward the target coverage area for the base station antenna 100 and the rear 100r of the base station antenna 100 facing the tower or other mounting structure. It will be appreciated that the base station antenna 100 may not always be mounted so that the longitudinal axis L thereof extends along a vertical axis. For example, the base station antenna 100 may be tilted slightly (e.g., less than) 10° with respect to the vertical axis so that the resultant antenna beams formed by the base station antenna 100 each have a small mechanical downtilt.

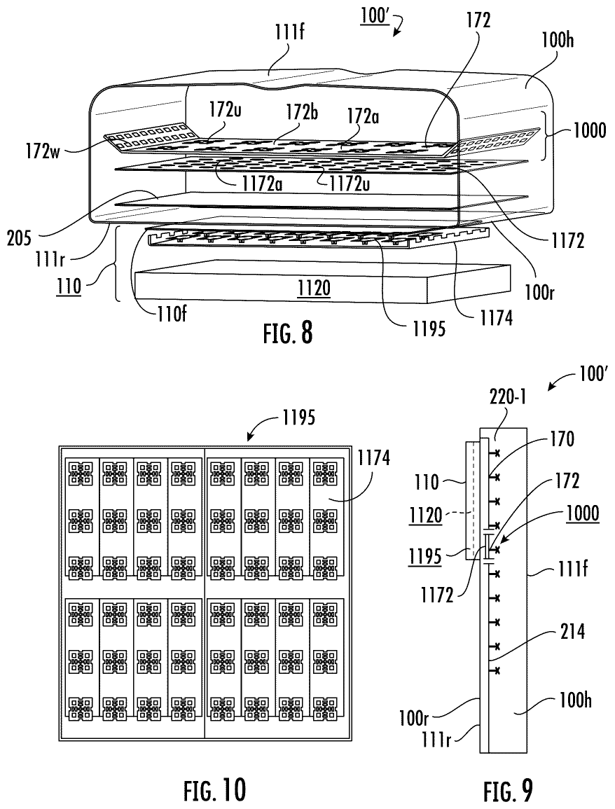

The base station antenna 100 can couple to or include at least one active antenna module 110. The term “active antenna module” is used interchangeably with “active antenna unit” and “AAU” and “active antenna” and refers to a cellular communications unit comprising radio circuitry and associated radiating elements. The radio circuitry is capable of electronically adjusting the amplitude and/or phase of the subcomponents of an RF signal that are output to different radiating elements of an array or groups thereof. The active antenna module 110 comprises the radio circuitry and the radiating elements (e.g., a multi-input-multi-output (mMIMO) beamforming antenna array) and may include other components such as filters, a calibration network, an antenna interface signal group (AISG) controller and the like. The active antenna module 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a front to back direction of the base station antenna 100, with the radiating elements 1195 of an antenna assembly 1190 of the AAU 110 closer to the front radome 111f of the housing 100h/radome 111 of the base station antenna 100 than the radio circuitry unit 1120 (FIGS. 8, 9). In some embodiments, the radiating elements 1195 may comprise a separate sub-unit from the radio circuitry and the radiating element sub-unit may be mounted within the base station antenna 100 instead of being external to the base station antenna 100.

The base station antenna 100 has a housing 100h. The housing 100h may be substantially rectangular with a flat rectangular cross-section. The housing 100h may be provided to define at least part of a radome 111 with at least the front side 111f configured as a dielectric cover that allows RF energy to pass through in certain frequency bands. The housing 100h may also be configured to that the rear 100r defines a rear side 111r radome opposite the front side radome 111f. Optionally, the housing 100h and/or the radome 111 can also comprise two (narrow) sidewalls 100s, 111s facing each other and extending rearwardly between the front side 111f and the rear side 111r. Typically, the top side 100t of the housing 100h may be sealed in a waterproof manner and may comprise an end cap 120 and the bottom 100b of the housing 100h may be sealed with a separate end cap 130. The front side 111f, the sidewalls 111s and typically at least part of the rear side 111r of the radome 111 are substantially transparent to radio frequency (RF) energy within the operating frequency bands of the base station antenna 100 and active antenna module 110. The radome 111 may be formed of, for example, fiberglass or plastic.

Still referring to FIG. 3, in some embodiments, an active antenna module 110 can attach to the base station antenna 100 using a frame 112 and accessory mounting brackets 113, 114. The rear 111r of the housing 100h may be a flat surface extending along a common plane over an entire longitudinal extent thereof or along at least a portion of the longitudinal extent thereof.

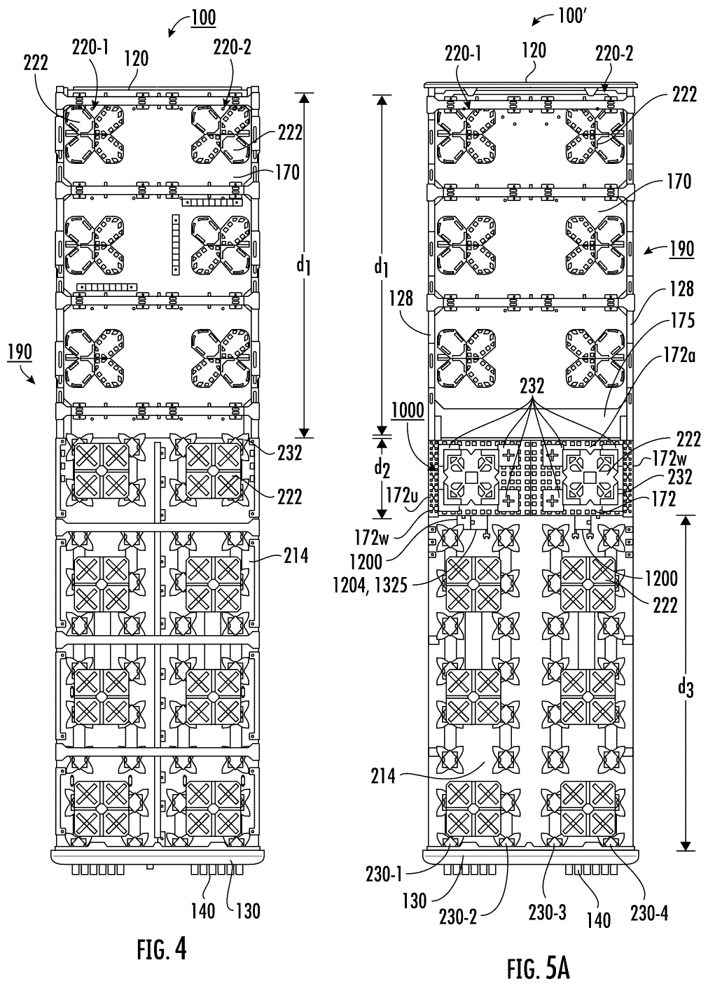

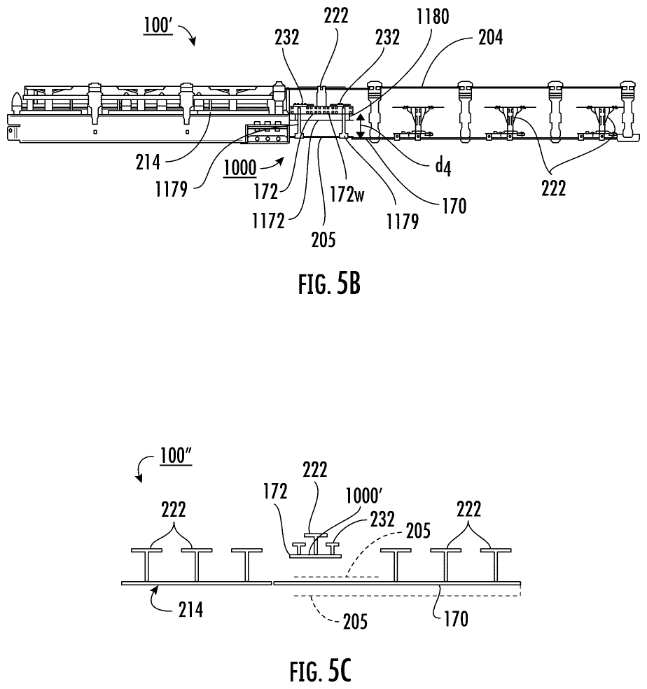

The base station antenna 100 includes an antenna assembly 190, which can be referred to as a “passive antenna assembly”. The term “passive antenna assembly” refers to an antenna assembly having arrays of radiating elements that are coupled to radios that are external to the antenna, typically remote radio heads that are mounted in close proximity to the base station antenna 100. The arrays of radiating elements included in the passive antenna assembly 190 (FIGS. 4, 5A) are configured to form static antenna beams (e.g., antenna beams that are each configured to cover a sector of a base station). The passive antenna assembly 190 can comprise a primary reflector 214 with some of the radiating elements projecting in front of the primary reflector and the radiating elements can include one or more linear arrays 220-1, 220-2 of low band radiating elements that operate in all or part of the 617-960 MHz frequency band and/or one or more linear arrays 230-1, 230-2 of mid-band radiating elements that operate in all or part of the 1427-2690 MHz frequency band. The passive antenna assembly 190 is mounted in the housing 100h of base station antenna 100 and one or more active antenna modules 110 can releasably (detachably) couple (e.g., directly or indirectly attach) to the housing 100h of base station antenna 100.

Referring to FIG. 3, in another embodiment, the rear surface 100r can comprise a plurality of longitudinally spaced apart mounting structure brackets, shown as upper, medial, and lower brackets, 115, 116, 117, respectively, that extend rearwardly from the housing 100h. In some embodiments, the mounting structure brackets 115, 116, 117 may be configured to couple to one or more mounting structures such as, for example, a tower, pole or building (not shown). At least two of the mounting structure brackets 115, 116 can also be configured to attach to the frame 112 of the base station antenna arrangement, where used. The frame 112 may extend over a sub-length of a longitudinal extent L of base station antenna 100, where the sub-length is shown in FIG. 3 as being at least a major portion thereof (at least 50% of a length thereof). The frame 112 can comprise a top 112t, a bottom 112b and two opposing long sides 112s that extend between the top 112t and the bottom 112b. The frame 112 can have an open center space 112c extending laterally between the sides 112s and longitudinally between the top 112t and bottom 112b.

The frame 112, where used, may be configured so that a variety of different active antenna modules 110 can be mounted to the frame 112 using appropriate accessory mounting brackets 113, 114. As such, a variety of active antenna modules 110 may be interchangeably attached to the same base station antenna 100. While the frame 112 is shown by way of example, other mounting systems may be used.

In some embodiments, a plurality of active antenna modules 110 may be concurrently attached to the same base station antenna 100 at different longitudinal locations using one or more frames 112. Such active antenna modules 110 may have different dimensions, for example, different lengths and/or different widths and/or different thicknesses.

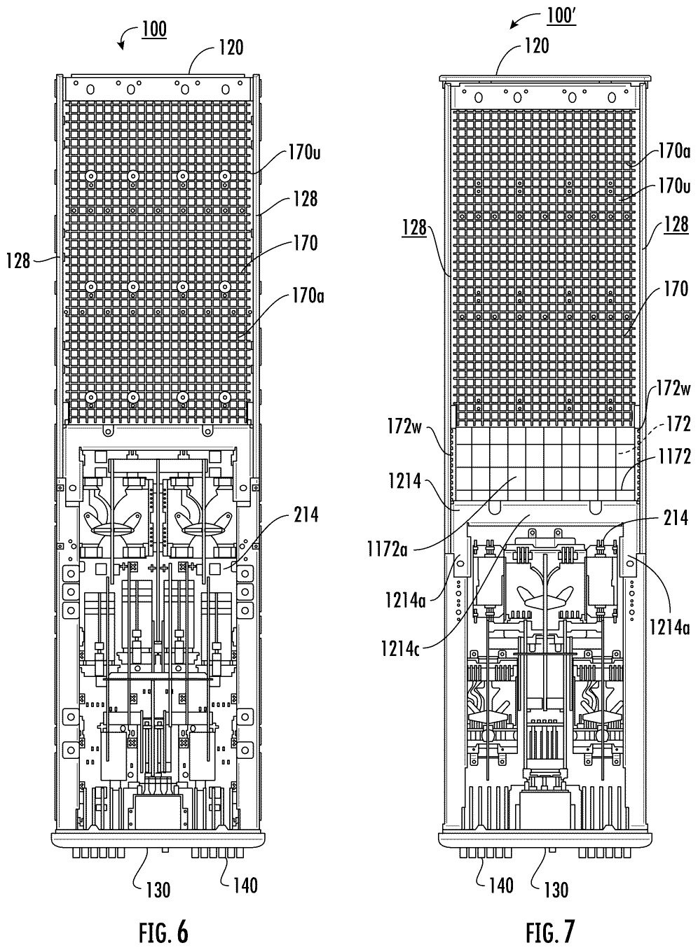

Referring to FIGS. 4 and 6, an example passive antenna 190 comprising a primary reflector 214 for a base station antenna 100 is shown. As shown, the primary reflector 214 resides below (in the longitudinal direction) a first frequency selective surface (FSS) 170 that extends above the primary reflector 214.

Turning now to FIGS. 5A, 5B and 7, in contrast to the passive antenna 190 shown in FIGS. 4 and 6, the base station antenna 100′ with the passive antenna 190 can have a supplemental FSS structure 1000 that resides between (in the longitudinal direction) the first FSS 170 and the primary reflector 214. The first FSS 170 can have a length “d₁”, the supplemental FSS structure 1000 can have a length “d₂” and the primary reflector 214 can have a length “d₃”. As shown, d₂ is less than d₁ and d₃. In some embodiments, the length d₂ of the supplemental FSS structure 1000 can be in a range of 10-30% of the length d₁ of the first FSS 170 and/or the length d₃ of the primary reflector 214. However, d₂ can have other lengths and is not limited to these example lengths.

Referring to FIG. 5A, a coupling segment 175 can optionally extend laterally between the rails 128 and can be used to attach a bottom portion of the first FSS 170 to a top portion of the supplemental FSS structure 1000. The coupling segment 175 can be metal or plastic or combinations thereof.

Referring to FIG. 7, the first FSS 170 can be provided as a metal grid layer or a printed circuit board with an array 170a of unit cells 170u configured to block and/or reflect RF energy from low band radiating elements 222 from the linear arrays 220-1, 220-2 of radiating elements 222. In some embodiments, the first FSS 170 is provided as a printed circuit board with the array 170a of unit cells 170u.

The first FSS 170 can terminate adjacent to a top portion of the supplemental FSS structure 1000.

The first FSS 170 can extend behind and partially overlap, in the longitudinal direction, the supplemental FSS structure 1000.

At least part of the supplemental FSS structure 1000, 1000′ (FIGS. 5B, 5C), respectively, can resides in a plane in front of a plane of the first FSS 170 and can have a longitudinal extent that resides only along a portion of the first FSS 170 (for example a bottom portion of the first FSS 170 as shown in FIG. 5C) or can be configured to reside entirely (longitudinally) below and not overlap with the first FSS 170 (FIG. 5B).

The supplemental FSS structure 1000 can comprise a metal grid layer 172 comprising an array 172a of unit cells 172u and a printed circuit board layer 1172 (FIGS. 7-9, 11) comprising an array 1172a of unit cells 1172u. The metal grid layer 172 and the printed circuit board layer 1172 can be aligned to reside in a substantially common footprint along a longitudinal direction and stacked in a front-to-back direction of the base station antenna 100′. The grid layer 172 and the printed circuit board layer 1172 can each comprise a separate and independent frequency selective surface in some embodiments so that the supplemental FSS structure 1000 comprises two different frequency selective surfaces.

Referring to FIGS. 5A, 5B, 8 and 9, the metal grid layer 172 can reside in front of the printed circuit board layer 1172. The metal grid layer 172 can have the same length as the printed circuit board layer 1172. The metal grid layer 172 can have a greater lateral extent than the printed circuit board layer 1172. In other embodiments, the positions of the metal grid layer 172 and the printed circuit board layer 1172 may be reversed so that the printed circuit board layer 1172 resides in front of the metal grid layer 172.

The metal grid layer 172 can have side walls 172w that angle outward in a forward direction from a plane of the primary body 172b of the metal grid layer 172. The side walls 172w can have a pattern of unit cells 172u that extend along a length thereof. The printed circuit board layer 1172 can terminate laterally inward of the side walls 172w of the metal grid layer 172.

Referring to FIG. 5B, the supplemental FSS structure 1000 can reside a distance d₄ in front of the first FSS 170. Support legs 1179 can extend behind the FSS structure 1000. Attachment members 1180 can couple the metal grid layer 172 to the printed circuit board layer 1172. A matching layer 205 can reside behind the supplemental FSS structure 1000, closer to the plane of the first FSS 170. Another matching layer 204 may extend in front of the first FSS 170 and the supplemental FSS structure 1000. The matching layer(s) can be configured to reduce reflections of RF energy emitted by an array of radiating elements positioned behind a respective matching layer(s). Further discussions of example matching layers and FSSs can be found in U.S. patent application Ser. No. 17/787,619, the contents of which are hereby incorporated by reference as if recited in full herein.

The base station antenna 100′ can have a pair of laterally spaced apart and longitudinally extending rails 128. The supplemental FSS structure 1000 can extend laterally between and be attached to the rails 128.

The supplemental FSS structure 1000 can be parallel to the first FSS 170 and/or the primary reflector 214.

Referring to FIG. 9, at least part of the supplemental FSS structure 1000 can reside in a common plane as the first FSS 170. However, the supplemental FSS structure 1000 can reside in any plane and can be in a different plane as the first FSS 170, including in front or behind the plane of the first FSS 170. As shown in FIG. 5A, for example, at least part of the supplemental FSS structure 1000 can reside in a plane that is in front of the plane of the first FSS 170.

Referring to FIG. 5A, the base station antenna 100′ can comprise a first linear array 220-1 of first radiating elements 222 and a second linear array 220-2 of first radiating elements 222. A single one of the first radiating elements 222 of the first linear array 220-1 of first radiating elements and a single one of the first radiating elements 222 of the second linear array 220-2 of radiating elements can be positioned forwardly of the supplemental FSS structure 1000. In some cases, a single one of the first radiating elements 222 of the second linear array 220-2 of radiating elements may project forwardly of the supplemental FSS structure 1000.

Still referring to FIG. 5A, the base station antenna 100′ can also comprise a plurality of columns 230-1, 230-2, 230-3, 230-4 of second radiating elements 232 that are laterally spaced apart. Only two rows of each of the plurality of columns 230-1, 230-2, 230-3, 230-4 of second radiating elements 232 project forward of the supplemental FSS structure 1000 in the example embodiment of FIG. 5A.

Referring to FIG. 7, the base station antenna 100′ can comprise a bracket 1214 that extends laterally between the pair of longitudinally extending rails 128. The bracket 1214 can be attached to a bottom portion of the supplemental FSS structure 1000 and to the primary reflector 214.

The bracket 1214 can have a U-shape with the arms 1214a of the U-shape facing downward over the primary reflector 214. The closed end 1214c of the U-shape is attached to the supplemental FSS structure 1000. The first FSS 170 can be attached to a top portion of the supplemental FSS structure 1000, spaced apart from the bracket 1214.

The metal grid layer 172 comprises an array 172a of unit cells 172u in a first pattern that extends across at least a major portion of a lateral dimension of the base station antenna 100 behind first and second linear arrays 220-1, 220-2 of first radiating elements 22, behind multiple columns 230-1, 230-2, 230-3, 230-4 of second radiating elements 232 and in front of a multiple-column array of third radiating elements 1195 (FIGS. 8, 9).

The supplemental FSS structure 1000 can be at a common electrical ground with the first FSS 170 and the primary reflector 214 in some embodiments.

The supplemental FSS structure 1000 can be configured to reflect and/or block RF energy in a first frequency band and in a second frequency band. The second frequency band includes frequencies in a range that is above the first frequency band and allows energy from mMIMO radiating elements 1195 in a third frequency band that comprise frequencies above the second frequency band, that are positioned behind the supplemental FSS structure 1000, to propagate therethrough. In some embodiments, one of the grid layer 172 and the printed circuit board layer 1172 may be configured to substantially reflect RF energy in the operating frequency band of the first radiating elements 220 and/or the second (mid-band) radiating elements 232 while substantially passing RF energy in the operating frequency band of the mMIMO radiating elements 1195, while the other of the grid layer 172 and the printed circuit board layer 1172 may be configured to substantially reflect RF energy in the operating frequency band of the second radiating elements 232 and/or the first radiating elements 222 while substantially passing RF energy in the operating frequency band of the mMIMO radiating elements 1195.

The base station antenna 100′ can comprise an active antenna unit/module 110 (FIG. 9) positioned behind a rear 100r of the housing 100h enclosing the first FSS 170, the supplemental FSS structure 1000 and the primary reflector 214.

The supplemental FSS structure 1000 and the first FSS 170 can be configured to allow RF energy in at least part of a 3.2-4.1 GHz frequency band to propagate therethrough.

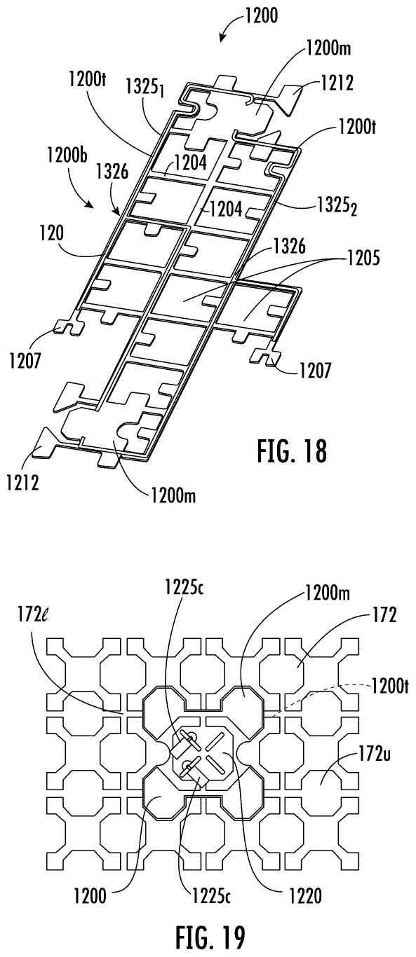

The base station antenna 100′ can include a plurality of feed boards 1200 coupled to the supplemental FSS structure 1000. At least some of the plurality of feed boards 1200 (FIGS. 5A, 18) can have a lattice body 1200b with apertures 1205 surrounded by linear segments 1204 defining at least first and second conductive signal traces 1325, and the first and second conductive signal traces 1325 can extend downward over the primary reflector 214 (FIG. 5A).

At least some of the linear segments 1204 of the feed boards 1200 align with metal segments forming unit cells 172u of the metal grid layer 172.

Referring to FIG. 5A, at least some of the linear segments 1204/1325 of the feed boards 1200 extend downward over the primary reflector 214.

In some embodiments, as shown in FIGS. 5B, 7, the first FSS 170 terminates above the supplemental FSS structure 1000.

In some embodiments, the metal grid layer 172 can be configured to block RF energy from mid-band radiating elements 232 and the printed circuit board layer 1172 can be configured to block RF energy from low-band radiating elements 222.

In other embodiments, the metal grid layer 172 can be configured to block RF energy from low-band radiating elements 222 and the printed circuit board layer 1172 can be configured to block RF energy from mid-band radiating elements 222.

In some embodiments, the metal grid layer 172 can be configured to block RF energy from low band radiating elements 222 and mid-band radiating elements 232 and the printed circuit board layer 1172 can be configured to block RF energy from low-band radiating elements 222 and mid band radiating elements 232.

The supplemental FSS structure 1000 can be used with the first FSS 170 and primary reflector 214 when longer arrays of third band radiating elements 1195 are used in an active antenna unit 110 and the supplemental FSS structure 1000 can be omitted for shorter versions of same thereby reducing manufacturing/assembly costs.

FIG. 8 is a simplified schematic illustration of the base station antenna 100′ showing the supplemental FSS structure 1000 with the stacked metal grid and printed circuit board layers 172, 1172, respectively, each with an array of unit cells 172a, 1172a. The pattern of the unit cells 172u, 1172u of the FSS 170 and/or the printed circuit board layer 1172 and/or the metal grid layer 172 can change over the length and/or laterally or may be the same. For example, a different arrangement of the unit cells 172u, 1172u may reside adjacent the second radiating elements 232 relative to the first radiating elements 222. The stacked layers 172, 1172 can abut or be spaced apart, in a front to back direction.

FIG. 5B shows the stacked layers 172, 1172 as closely spaced apart in the front to back direction a distance that can be in a range of 0.1 mm to 35.4 mm, such as about 21 mm.

FIG. 5C shows that the supplemental FSS structure 1000′ can be configured to provide only the metal grid layer 172 and position the metal grid layer 172 in front of a portion of the first FSS 170 whereby the first FSS 170 extends behind and across/along a portion or all of the supplemental FSS structure 1000′. A subset of the radiating elements 222 in the first array 220-1 and the second array 220-2 project forward of the first FSS 170 and another smaller subset (e.g., 1-4) project forward of the supplemental FSS structure 1000′ while yet a third subset project forward of the primary reflector 214.

As shown in FIG. 5C, a first subset of the first frequency band radiating elements 222 overlap the reflector 214 in a forward direction that is perpendicular to a plane defined by a major surface of the reflector 214 and a second subset of the first frequency band radiating elements 222 overlap the first FSS 170 in the forward direction. The supplemental frequency selective surface (FSS) structure 1000′ overlaps the first FSS 170 and at least one of the first frequency band radiating elements 222 in the second subset of the first frequency band radiating elements in the forward direction but does not overlap all of the first frequency band radiating elements 222 in the second subset of the first frequency band radiating elements in the forward direction.

Both the supplemental FSS structure 1000, 1000′ and the first FSS 170 can be provided in multiple layers of the same or different pattern units.

The first FSS 170 can reside behind and longitudinally above the FSS structure 1000.

As shown in FIG. 9, the supplemental FSS structure 1000 can be parallel to the primary reflector 214 and the first FSS 170, typically aligned with one or both in a front-to-back direction of the base station antenna 100′ to reside at least partially in a common longitudinally extending plane with one or both of the first FSS 170 and the primary reflector 214.

FIG. 10 illustrates an example configuration of an array of radiating elements 1195 for the active antenna unit 110.

FIG. 11 illustrates the supplemental FSS structure 1000 with different configurations of unit cells 172u, 1172u, sandwiched between front and back matching layers 203, 205, respectively and between front and rear radome surfaces 111f, 111r, respectively.

The unit cells 170a, 1172a of the two components may have the same or different configurations of unit cells over at least some parts thereof.

The supplemental FSS structure 1000 of FIGS. 5A, 5B, 5C, 7 can provide a similar performance for gain, directivity and/or CPR as the arrangement of FIG. 4 while allowing the second radiating elements 222 to be mounted forwardly of the mMIMO radiating elements 1195.

In some embodiments, the supplemental FSS structure 1000 can be electrically and mechanically coupled to the primary reflector 214 and the first FSS 170.

The first FSS 170 and the printed circuit board layer 1172 of the supplemental FSS structure 1000 can be provided as a non-metallic substrate(s) with conductive metal patches arranged to define an array of unit cells 170u, 1172u, respectively. The term “unit cells” is also interchangeably referred to as “pattern units”. While the printed circuit board layer 1172 is described as a “layer”, the term “layer” is used broadly and can refer to a component that multiple layers, for example, the printed circuit board layer 1172 is typically a multi-layer printed circuit board which can be configured as a rigid, semi-rigid member or as a flex circuit.

In some embodiments, the first FSS 170 and/or the supplemental FSS structure 1000 can comprise one or more non-metallic substrates which can be or comprise a plastic, polymer, co-polymer and/or dielectric with a metallized surface(s) providing conductive patches defining at least part of the array of unit cells.

The metal grid layer 172 can be provided as a sheet of metal, such as aluminum, with the sheet metal shaped to form the array 172a of unit cells 172u. The array of unit cells 172u can be punched, etched or laser formed apertures that are formed through the sheet metal, or can be otherwise formed.

The term “FSS” refers to a frequency selective surface(s) and/or substrate (referred to interchangeably as a “frequency selective surface” and “frequency selective reflector”) that is configured to allow RF energy (electromagnetic waves) to pass through in one or more first frequency bands and that is configured to reflect RF energy at one or more different second frequency bands. Thus, the frequency selective surface and/or substrate may also be interchangeably referred to as a “FSS” herein. The FSS can selectively reject some frequency bands and permit other frequency bands to pass therethrough by including the frequency selective surface and/or substrate to operate as a type of “spatial filter”. See, e.g., Ben A. Munk, Frequency Selective Surfaces: Theory and Design, ISBN: 978-0-471-37047-5; DOI:10.1002/0471723770; April 2000, Copyright © 2000 John Wiley & Sons, Inc. the contents of which are hereby incorporated by reference as if recited in full herein.

The frequency selective surface and/or substrate material can comprise one or more of a metamaterial, a suitable RF material or even air (although air may require a more complex assembly). The term “metamaterial” refers to composite electromagnetic (EM) materials. Metamaterials may comprise sub-wavelength periodic microstructures.

The FSS material of the first FSS 170 and/or the printed circuit board layer 1172 can be provided as one or more cooperating layers. The FSS material can include a substrate that has a dielectric constant in a range of about 2-4, such as about 3.7 and a thickness of about 5 mil and metal patterns forming unit cells 170u, 1172u formed on the dielectric substrate. The thickness can vary but thinner materials can provide lower loss.

In some embodiments, the metal grid layer 172 and the first FSS 170 can be configured to act like a High Pass Filter essentially allowing low band energy (e.g., energy in the 600-1000 MHz frequency range) to substantially reflect (the FSS can act like a sheet of metal) while allowing higher band energy, for example, about 3.5 GHz or greater, to substantially pass through.

The first FSS 170 and the supplemental FSS structure 1000, 1000′ are substantially transparent or invisible to the higher band energy and provides a suitable out of band rejection response. The FSS material may allow a reduction in filters or even eliminate filter requirements for looking back into the radio 1120 (FIGS. 8, 9).

The first FSS 170 and the supplemental FSS structure 1000, 1000′ may be provided at positions corresponding to the installation position of the active antenna module 110 of the base station antenna 100′ and may be configured to allow electromagnetic waves within a predetermined frequency range (for example, high-frequency electromagnetic waves within the range of 2300 to 4200 MHz or a portion thereof) to pass. In this way, when the base station antenna 100′ is assembled, the high-frequency electromagnetic waves emitted by the active antenna module 110 can pass through the first FSS 170 and the supplemental FSS structure 1000, 1000′.

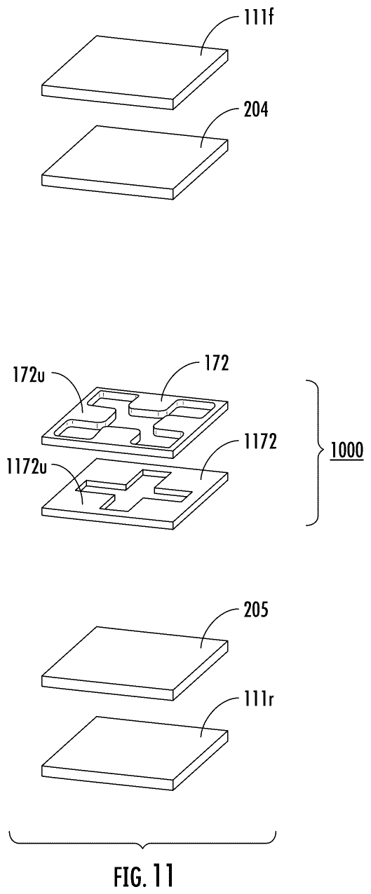

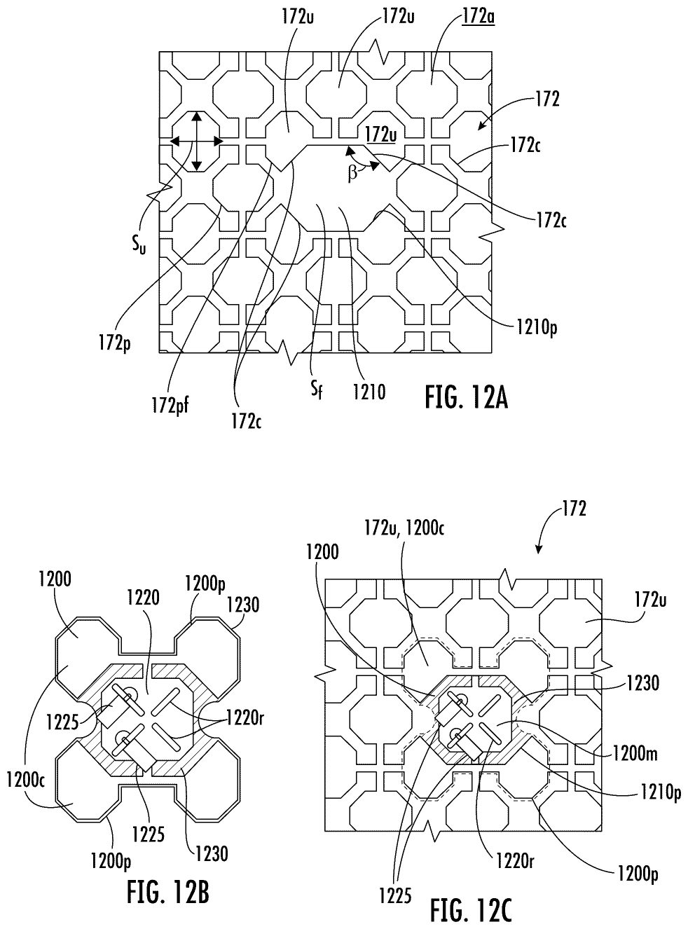

Referring to FIGS. 12A-12C, the metal grid layer 172 comprises a feed board aperture 1210 and a corresponding feed board 1200 that covers some or all of a corresponding feed board aperture 1210. FIG. 12A shows the metal grid layer 172 with an example feed board aperture 1210 and perimeter 1210p of the feed board aperture 1210. FIG. 12B shows an example feed board 1200 with feed stalk 1220 and FIG. 12C illustrates an assembled view of the metal grid layer 172 shown in FIG. 12A and the feed board 1200 shown in FIG. 12B.

Referring to FIG. 12C, the metal grid layer 172 can comprise the array of unit cells or pattern units 172u. A plurality of pattern units 172u can surround the feed board aperture 1210. The perimeter 1210p of the feed board aperture 1210 can extend through one or more of the pattern of units 172u so that the unit cells 172u about the perimeter 1210p are incomplete patterns relative to other unit cells 172u and hence have a different shape than other unit cells 172u. The feed board perimeter 1210p can define a plurality of corner segments 172c of a set of unit cells surrounding the feed board perimeter 1210p. The corner segments 172c can be curvilinear and may have a portion that extends at an angle β (see FIG. 12A) that is different and/or that has a different length than corner segments 172c of unit cells 172u that are spaced apart from the feed board aperture 1210. In some embodiments, the angle β can be between 30-60 degrees from horizontal. The unit cells 172u surrounding a respective feed board aperture 1210, shown as four unit cells 172u in FIG. 12A, can have perimeter 172pf that has a different shape than perimeters 172p of other unit cells 172u.

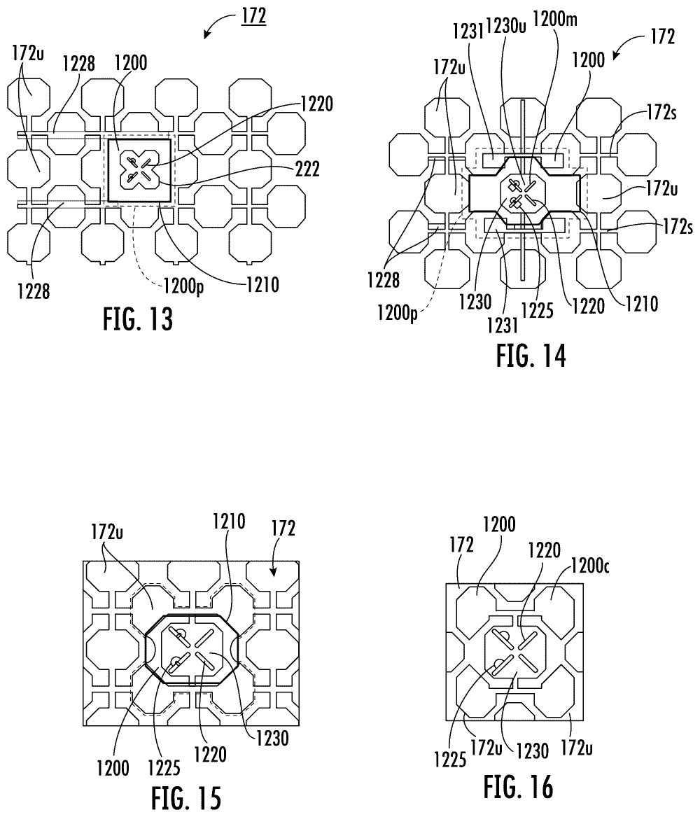

The feed board 1200 can have a perimeter 1200p and/or shaped portion 1200m (FIGS. 12C, 14) configured to cooperate with the metal grid layer 172 so as to replicate at least part of the unit cell 172u structure thereof. The feed board 1200 can have at least a portion that has a shape that corresponds to a shape of a unit cell 172u (or to part of a shape of a unit cell 172u). FIG. 12B illustrates that the perimeter 1200p is curvilinear and comprises four corner segments 1200c that have a shape of corresponding unit cells 172u. FIG. 12C illustrates that the corner segments 1200c can reside over or under corresponding unit cells 172u when assembled. The feed board 1200 can reside in front of the metal grid layer 172 or behind the metal grid layer 172. The corner segments 1200c can be coupled to front or rearward facing surfaces of corresponding ones of the unit cells 172u of the metal grid layer 172. The corner segments 1200c on a front or rear facing primary surface can comprise a conductive metal such as copper and define part of a ground layer 1230. As shown, the ground layer 1230 is not continuous across the front or rear of the entire feed board 1200 so that the pattern of the unit cells 172u is replicated on the feed board 1200.

The ground layer 1230 of the feed board 1200 can cooperate with the metal grid layer 170 to form part of the unit cell structure and/or function of the FSS of the grid layer 172.

The feed board aperture 1210 can have a surface area Sf that is greater than the surface area Su of a unit cell 172u, typically greater than at least two of the unit cells 172u and less than 10 (ten) of the unit cells 172u, where the unit cells 172u can have the same surface area, or have an average of the max and min, where they are different. It will be appreciated, however, that since the feed board 1200 replicates the pattern of the unit cells 172u and hence acts as an FSS surface, the feed board apertures 1210 can have any size and may replace a larger number of unit cells 172u of the metal grid layer 172, in some embodiments.

The feed stalks 1220 for each radiating element 222 may comprise printed circuit board-based feed stalks in some embodiments, although die cast or sheet metal feed stalks may alternatively be used. When implemented using printed circuit boards, a feed stalk 1220 may comprise a pair of printed circuit boards that have cooperating slots that allow the two printed circuit boards to be joined together where the printed circuit boards are rotated 90 degrees with respect to each other, as is well known in the art. In such embodiments, each printed circuit board typically includes two rearwardly-extending tabs 12207, which facilitates fixedly mounting the radiating element 222 to the feed board 1200 via soldering. The feed stalk 1220 can have a plurality of rearwardly-extending tabs 12201, shown as four tabs in the depicted embodiments, that extend rearwardly through the feed board 1200. Two coaxial feed cables 1225 (one for each polarization) (FIG. 14) can be provided and can reside behind the grid layer 172. Each coaxial cable 1225 can be connected to one of the rearwardly-extending tabs 1220l of a respective one of the printed circuit boards of the 1220 in order to pass RF signals between the radiating element 222 and a feed network for the passive antenna assembly 190.

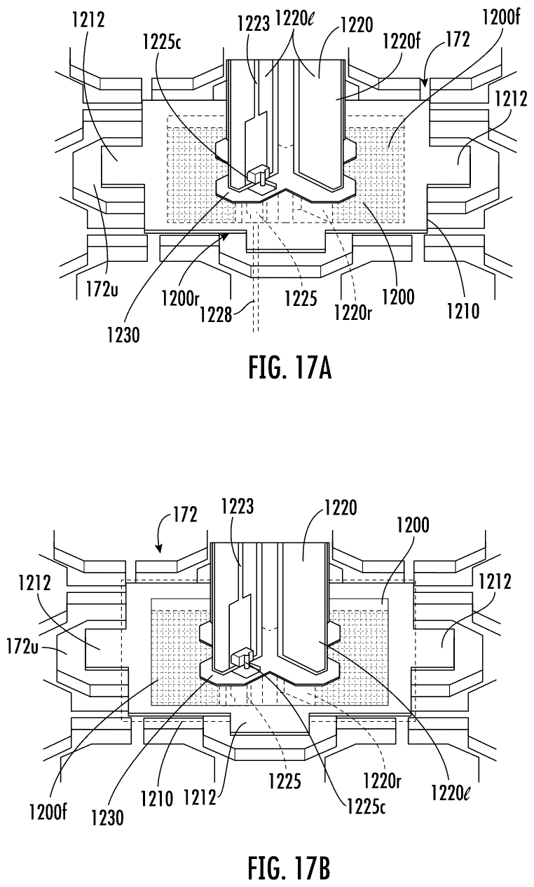

Since the coaxial cables 1225 can couple directly to the feed stalks 1220 behind the feed board 1200, no signal transmission traces are required on a front surface of the feed board 1200, e.g., the front surface 1200f of the feed board 1200 can be devoid of metal. One primary surface of the feed board 1200 can comprise a conductive electrical ground layer 1230 which can be a copper layer. The ground layer 1230 can be on a rear primary surface 1200r (FIG. 17A) or a front primary surface 1200f (FIG. 17B). The ground layer 1230 can be configured to occupy only a sub-portion of a surface area of the primary front or rear surface of the feed board 1200 can be provided by patterned segments thereon.

Referring to FIGS. 17A and 17B, for example, a center conductor 1225c of the coaxial cables 1225 can connect to a signal trace 1223 on a forward portion 1220f of at least one tab 1220l of the feed stalk 1220 and the ground conductor of the coaxial cable can connect to a ground plane on the feed board 1200.

FIG. 13 illustrates the feed board aperture 1210 can be polygonal, such as square or rectangular and can couple to a single feed board 1200 with a feed stalk 1220 of a single radiating element 222 or 232. The feed board 1200 or at least a portion hat is a shaped segment 1200m in the form of all or part of a unit cell 172u does not require, and is typically devoid of, signal transmission traces. The feed board 1200 can have a perimeter 1200p (shown in broken line in front of the rear surface of the grid layer 172) with at least a portion that extends beyond the feed board aperture 1210 to physically couple to the grid layer 172 thereat.

FIG. 14 illustrates another configuration of a feed board aperture 1210 and feed board 1200. The ground layer 1230 of the feed board 1200 can have a unit cell shaped segment 1230u that is shaped to mimic or be the same as a unit cell 172u of the grid layer 172. The ground layer 1230 may also include ground strips 1231 that align with metal strips 172s of the array of unit cells 172u (and plates) that can capacitively couple with metal of the grid layer 172, such as to one or more unit cells 172u, to provide a capacitive connection between the grid layer 172 and the feed board 1200.

FIGS. 15 and 16 illustrate a feed board aperture 1210 and feed board 1200 similar to that shown in FIGS. 12A-12C. The feed board 1200 includes a ground layer 1230 which has shaped corner segments 1200c with a primary surface thereof defining part of a ground layer 1230 and a shaped segment 1230m that is coupled to the feed stalk 1220. The ground layer 1230 is discontinuous across an entire primary surface of the feed board 1200 in contrast to conventional feed boards.

FIGS. 14-16, for example, show embodiments whereby at least a portion of the structure of the unit cell 172u of the grid layer 172 is replicated and/or formed on the feed board 1200 to provide a continuous unit cell structure using the combination of the unit cells 172u of the grid layer 172 and the feed board 1200. The metal pattern on the feed board 1200 can be capacitively coupled to the grid layer 172 by having overlapping portions with the same shape and/or pattern. The result is that the feed boards 1200 and grid layer 172 together act like a grid reflector providing the FSS. This allows mid-band and/or low-band radiating elements to be positioned in front of and over or on the grid layer 173 and to feed those radiating elements without any substantial compromise in the performance thereof. The metal pattern on the feed board 1200 can have the same shape as the metal pattern of the grid layer 172 and the metal on feed board 1200 can couple to the metal of the metal grid layer 172.

In other embodiments, the metal grid layer 173 is not required to electrically couple with metal on the feed board 1200.

The metal on the feed board 1200 can combine with the cutout/aperture 1210 to contribute the same pattern or pattern feature of all or a portion of one or more unit cells 172u of the grid layer 172.

FIG. 17A illustrates that the ground layer 1230 can be provided on a rear surface 1200r of the feed board 1200 and no signal transmission traces for the radiating element(s) are required on the front surface 1200f. As shown, the center conductor 1225c of the coaxial feed cable 1225 can be directly soldered to the feed stalk 1220. The ground conductor 1225c of the coaxial feed cable 1225 can be directly soldered to the ground layer 1230 on the rear surface 1200r of the feed board 1200.

FIG. 17B illustrates that the ground layer 1230 can be provided on a front surface 1200f of the feed board 1200 and no signal traces for the radiating element(s) are required on the front surface 1200f. As shown, the coaxial feed cable 1225 can extend through a hole in the feed board 1200 to the front side thereof. The center conductor 1225c of the coaxial feed cable 1225 can be directly soldered to the feed stalks 1220, and the ground conductor of the coaxial feed cable 1225 can be directly soldered to the ground layer 1230 on the front surface 1200r of the feed board 1200.

FIGS. 17A and 17B also illustrate fastening segments 1212 on outer perimeter portions of the feed board 1200 configured to couple to unit cells 172u of the grid layer 172. The fastening segments 1212 can be provided in any suitable number, typically in a range of 2-4. The fastening segments 1212 provide a structure for fastening the feed board 1200 to the grid layer 172 (e.g., by soldering, by fasteners, by adhesive tape, etc.), and may also form capacitive connections between the ground layer or plane 1230 on the feed board 1200 and the grid layer 172 so that both structures are at a common ground potential. In FIG. 17A, the center conductor is at the bottom side of the feed board 1200 (printed circuit board). One difference between FIGS. 17A and 17B is the solder joint between the center conductor and dipole stalk. The solder joint in FIG. 17A is at bottom, and the solder joint in FIG. 17B is at the top side.

While the above discussion assumed a capacitive connection between the feed board 1200 and the metal grid layer 172, embodiments of the present invention are not limited thereto. In other embodiments, the feed board 1200 can be galvanically electrically coupled to the grid layer 172 (e.g., by soldering).

The radiating elements in front of the metal grid layer 172 can comprise low band 222 and/or mid band 232 radiating elements (FIG. 5).

The feed board 1200 can cooperate with the grid layer 172 to reflect energy of the low band and/or mid band radiating elements while being transparent or “invisible” to high band radiating elements, such as mMIMO elements 1195 (FIGS. 8, 9) positioned behind the first FSS layer 170 and the supplemental FSS 1000 with the grid layer 172.

The pattern units or unit cells 172u can be periodically arranged in the transverse and longitudinal directions of the base station antenna 100. Each of the pattern units/unit cells 172u may have a predetermined pattern and may include a capacitor structure and an inductor structure connected in series and/or parallel with the capacitor structure. In addition, each of the pattern units 172u may be electrically connected to each other through the inductor structure. For example, the inductor structure in each pattern unit/unit cell 172u may be electrically connected to the inductor structure of an adjacent pattern unit.

The resonance frequency of the frequency selective surface of the grid layer 172 and the printed circuit board layer 1172 may be configured by selecting or designing the pattern and size of the capacitor structure and the inductor structure of each pattern unit/unit cell 172u,1172u as well as the spacing and arrangement of a plurality of pattern units 172u, 1172u such that the electromagnetic waves within a predetermined frequency range can pass through the frequency selective section.

In addition, the unit cells/pattern units 172u may have various shapes, such as triangle, rectangle, rhombus, pentagon, hexagon, circle, oval, part oval, and the like and combinations of different shapes for different unit cells. Further description of example FSS grids can be found in co-pending PCT/CN2022/080578, the contents of which are hereby incorporated by reference as if recited in full herein.

In some embodiments according to the present disclosure, the first FSS 170 and the printed circuit board layer 1172 can comprise a patch type frequency selective section, which may be achieved by forming periodically arranged metal pattern units on a substrate. The plurality of metal pattern units may be formed on the substrate by a selective electroplating process or a metal ink transfer printing process. In some embodiments, the substrate may be formed of plastic, and the metal pattern unit may be formed of metal materials such as copper, aluminum, gold, and silver. In order to increase the strength of the frequency selective surface, the substrate may be formed of high-strength plastic.

The grid layer 172 and/or the printed circuit board layer 1172 can reside a distance in a range of ⅛ wavelength to ¼ wavelength of an operating wavelength behind the low band (dipole) radiating elements 222, in some embodiments. The term “operating wavelength” refers to the wavelength corresponding to the center frequency of the operating frequency band of the radiating element, e.g., a low band radiating element 222. The grid layer 172 and/or the printed circuit board layer 1172 can reside a distance in a range of 1/10 wavelength to ½ wavelength of an operating wavelength in front of the high band radiating elements 1195 (FIGS. 8, 9), in some embodiments. By way of example, in some particular embodiments, the grid layer 172 and/or the printed circuit board layer 1172 can reside a physical distance of 0.25 inches and 2 inches from a ground plane or reflector 1174 that is behind a mMIMO array of radiating elements 1195 of an active antenna module 110 (FIGS. 8, 9). Other placement positions may be used.

In some embodiments, the ground plane or reflector 1174 (FIG. 8) of the active antenna module 110 can be electrically coupled to the supplemental FSS structure 1000 and/or the first FSS 170 and/or the primary reflector 214 of the base station antenna 100′, such as galvanically and/or capacitively coupled. In other embodiments, the ground plane or reflector 1174 of the active antenna module 110 is not electrically coupled to the supplemental FSS structure 1000, the first FSS 170 and the primary reflector 214.

Referring to FIG. 5A, the passive antenna assembly 190 comprises multiple arrays of radiating elements, typically provided in four to eight columns, with radiating elements that extend forwardly from the front side of the primary reflector 214, with some columns of radiating elements continuing to extend in front of the first FSS 170 and the grid layer 172. The arrays of radiating elements of the antenna assembly 190 may comprise radiating elements 222 that are configured to operate in a first frequency band and radiating elements 232 that are configured to operate in a second frequency band. Other arrays of radiating elements may comprise radiating elements that are configured to operate in either the second frequency band or in a third frequency band. The first, second and third frequency bands may be different frequency bands (although potentially overlapping). In some embodiments, some low band antenna elements 222 with dipole arms can reside in front of the first FSS layer 170, others in front of the primary reflector 214 and yet others can reside in front of the supplemental FSS structure 1000, 1000′.

The passive antenna assembly 190 of the base station antenna 100 can include one or more arrays of low-band radiating elements 222, one or more arrays of mid-band radiating elements 232. The radiating elements 222, 232, 1195 may each be dual-polarized radiating elements. Further details of radiating elements can be found in co-pending WO2019/236203 and WO2020/072880, the contents of which are hereby incorporated by reference as if recited in full herein. Some of the high band radiating elements, such as radiating elements 1195, can be provided as a mMIMO antenna array and may be provided in the active antenna module 110 rather than in the housing 100h of the base station antenna 100.

The low-band radiating elements 222 can be mounted to extend forwardly from the main or primary reflector 214, the first FSS 170 and the supplemental FSS structure 1000, 1000′ and can be mounted in two columns to form two linear arrays 220-1, 220-2 of low-band radiating elements 222. Each low-band linear array 220-1, 220-2 may extend along substantially the full length of the antenna 100 in some embodiments.

The low-band radiating elements 222 may be configured to transmit and receive signals in a first frequency band. In some embodiments, the first frequency band may comprise the 617-960 MHz frequency range or a portion thereof (e.g., the 617-896 MHz frequency band, the 696-960 MHz frequency band, etc.). The low-band linear arrays may or may not be used to transmit and receive signals in the same portion of the first frequency band. For example, in one embodiment, the low-band radiating elements 222 in a first linear array may be used to transmit and receive signals in the 700 MHz frequency band and the low-band radiating elements 222 in a second linear array may be used to transmit and receive signals in the 800 MHz frequency band. In other embodiments, the low-band radiating elements 222 in both the first and second linear arrays may be used to transmit and receive signals in the 700 MHZ (or 800 MHZ) frequency band.

Some of the mid-band radiating elements 232 may likewise be mounted to extend forwardly from the supplemental FSS structure 1000, 1000′ and some from the main reflector 214 and may be mounted in columns to form linear arrays of first mid-band radiating elements. The mid-band radiating elements 232 may be configured to transmit and receive signals in a second frequency band. In some embodiments, the second frequency band may comprise the 1427-2690 MHz frequency range or a portion thereof (e.g., the 1710-2200 MHZ frequency band, the 2300-2690 MHz frequency band, etc.). In the depicted embodiment, the mid-band radiating elements 232 are configured to transmit and receive signals in the lower portion of the second frequency band (e.g., some or all of the 1427-2200 MHz frequency band). The linear arrays of mid-band radiating elements 232 may be configured to transmit and receive signals in the same portion of the second frequency band or in different portions of the second frequency band.

Other mid-band radiating elements can be mounted in columns to form linear arrays of second mid-band radiating elements and may be configured to transmit and receive signals in the second frequency band. By way of example, the mid-band radiating elements can transmit and receive signals in an upper portion of the second frequency band (e.g., some, or all, of the 2300-2700 MHz frequency band). There can be first and second mid-band radiating elements and may have a different design from each other.

The high-band radiating elements 1195 may be configured to transmit and receive signals in a third frequency band. In some embodiments, the third frequency band may comprise the 3300-4200 MHz frequency range or a portion thereof.

It will also be appreciated that the number of linear arrays of low-band, mid-band and high-band radiating elements may be varied from what is shown in the figures. For example, the number of linear arrays of each type of radiating elements may be varied from what is shown, some types of linear arrays may be omitted and/or other types of arrays may be added, the number of radiating elements per array may be varied from what is shown, and/or the arrays may be arranged differently. As one specific example, two linear arrays of second mid-band radiating elements may be replaced with four linear arrays of ultra-high-band radiating elements that transmit and receive signals in a 5 GHz frequency band.

Each array of low-band radiating elements 222 may be used to form a pair of antenna beams, namely an antenna beam for each of the two polarizations at which the dual-polarized radiating elements are designed to transmit and receive RF signals. Likewise, each array of mid-band radiating elements 232 may be configured to form a pair of antenna beams, namely an antenna beam for each of the two polarizations at which the dual-polarized radiating elements are designed to transmit and receive RF signals. Each linear array may be configured to provide service to a sector of a base station. For example, each linear array may be configured to provide coverage to approximately 120° in the azimuth plane so that the base station antenna 100′ may act as a sector antenna for a three-sector base station. Of course, it will be appreciated that the linear arrays may be configured to provide coverage over different azimuth beamwidths. While all of the radiating elements 222, 232, 1195 can be dual-polarized radiating elements in the depicted embodiments, it will be appreciated that in other embodiments some or all of the dual-polarized radiating elements may be replaced with single-polarized radiating elements. It will also be appreciated that while the radiating elements are illustrated as dipole radiating elements in the depicted embodiment, other types of radiating elements such as, for example, patch radiating elements may be used in other embodiments.

As the radiating elements 222, 232 can be slant cross-dipole radiating elements, the first and second polarizations may be a −45° polarization and a +45° polarization.

A phase shifter (FIG. 7) may be connected to a respective one of the RF ports 140 (FIG. 3, 7). The phase shifters may be implemented as, for example, wiper arc phase shifters such as the phase shifters disclosed in U.S. Pat. No. 7,907,096 to Timofeev, the disclosure of which is hereby incorporated herein in its entirety. A mechanical linkage may be coupled to a RET actuator (not shown). The RET actuator may apply a force to the mechanical linkage which in turn adjusts a moveable element on the phase shifter in order to electronically adjust the downtilt angles of antenna beams that are generated by the one or more of the low-band or mid-band linear arrays.

It should be noted that a multi-connector RF port (also referred to as a “cluster” connector) can be used as opposed to individual RF ports 140. Suitable cluster connectors are disclosed in U.S. patent application Ser. No. 16/375,530, filed Apr. 4, 2019, the entire content of which is incorporated herein by reference.

The radiating elements 222 can be cross-dipole elements configured to operate in some or all the 617-960 MHz frequency band. The signal trace 1223 on the feed stalk 1220 (FIGS. 17A, 17B) can be a feed circuit comprising a hook balun. Further discussions of example antenna elements including antenna elements comprising feed stalks can be found in U.S. Provisional Patent Application Ser. Nos. 63/087,451 and 62/993,925 and/or related utility patent applications claiming priority thereto, the contents of which are hereby incorporated by reference as if recited in full herein.

Turning now to FIGS. 18, 19, an example feed board 1200 is shown with the grid layer 172. In this embodiment, the feed board 1200 has a plurality of spaced apart linear segments 1204 surrounding one or more cutouts or apertures 1205 forming an open lattice type body 1200b. The linear segments 1204 can comprise at least one signal trace 1200t, shown as a plurality of signal traces 1200t, that can define a respective at least one, and preferably a plurality of, conductor signal paths 1325, shown as a first conductor signal path 13251 and an electrically isolated second conductor signal path 13252, each with a respective power splitter or divider 1326 that diverts the corresponding signal from center conductors 1225c of coaxial cables 1225 to at least respective first and second shaped segments 1200m that align with respective feed stalks 1220. The shaped segments 1200m can have at least part of a curvilinear shape of a corresponding unit cell 172u of the grid layer 172. The feed boards 1200 can define more than two conductive signal traces 1200t for more than two signal paths 1325 or a single signal trace for a single conductive signal path 1325. The signal traces 1200t can be provided as microstrip signal traces.

The signal traces 1200t and the grid layer 172 may together form a series of microstrip transmission lines that are used to carry RF signals between one or more arrays of radiating elements of the base station antenna 100′ and other components (e.g., phase shifters) of the base station antenna 100′. In particular, the signal traces 1200t may act as the signal traces of the microstrip transmission lines and the metal grid layer 172 may act as the ground plane of the microstrip transmission lines. The signal traces 1200t may be separated from the grid layer by a dielectric layer such as, for example, an air gap, a solder mask or a dielectric substrate of a printed circuit board. In some embodiments, the grid layer 172 may be formed as a metal layer on a first side of a dielectric substrate (e.g., the dielectric substrate of a printed circuit board) and the signal traces 1200t may be formed as a metal pattern on a second side of the dielectric substrate.

In embodiments where the metal grid layer 172 and the feed boards 1200 are separate elements, each of the feed boards 1200 can comprise fastening segments 1212 for attaching the feed board 1200′ to the grid layer 172.

Each of the feed boards 1200 can have first and second cable connectors 1207 that attach to respective coaxial cables 1225 (FIG. 14) and connect to the signal traces 1200t corresponding to respective first and second conductor signal paths 13251, 13252. In particular, the center conductors of coaxial cables 1225 (FIG. 14) connect to the signal traces 1200t corresponding to respective first and second conductor signal paths 13251, 13252. The ground conductors of coaxial cables 1225 (FIG. 14) may be connected to the grid layer 172.

The signal traces 1200t can be arranged as a series of lateral and longitudinal linear segments 1204 that align with metal linear features of the grid layer 172. Such an arrangement acts to convert the signal traces 1200t into microstrip transmission lines (since it locates a ground conductor behind each signal trace 1200t) and also locates the signal traces 1200t so that they do not block the openings in the structure of the unit cells 172u, which could reduce the performance of the frequency selective surface. The apertures 1205 of the lattice body 1200b can be sized and configured to provide an open window in front or behind a plurality of unit cells 172u of the grid layer 172. A first subset of the linear segments 1204 can provide the first conductor signal path 13251 and a second subset of the linear segments 1204 can provide the second conductor signal path 13252. As noted above, in some embodiments the lattice body 1200b can be selectively metallized on a non-conductive substrate (e.g., a printed circuit board implementation), but it will be appreciated that the lattice body 1200b alternatively could be formed from sheet metal or in other ways. It will also be appreciated that some or all of the linear segments 1204 may be replaced with non-linear segments such as curved segments or meandered segments. This is particularly true in cases where the unit cells 172u of the grid layer 172 have non-linear segments, as performance may be improved in situations where the lattice body 1200b matches the underlying grid structure.

In some embodiments, the apertures 1205 can be cutouts in the dielectric of the printed circuit board providing the signal traces 1200t and respective conductor signal paths 13251, 13252. In other embodiments, the apertures 1205 can be non-metallized regions in the dielectric of a printed circuit board that provides the signal traces 1200t and respective conductor signal paths 13251, 13252.

The feed boards 1200 can be for any radiating elements that operate in any frequency band such as low band radiating elements 222 and/or mid band radiating elements 232.

Additional discussion of example grid structures, feed boards and stalks can be found in U.S. patent application Ser. No. 18/326,239 or US2023/0395987, the contents of which are hereby incorporated by reference as if recited in full herein.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.)

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The term “about” used with respect to a number refers to a variation of +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a first frequency selective surface (FSS);
a primary reflector; and
a supplemental frequency selective surface (FSS) structure residing between the first FSS and the primary reflector in a longitudinal direction.

2. The base station antenna of claim 1, wherein the supplemental FSS structure comprises a metal grid layer comprising an array of unit cells and a printed circuit board layer comprising an array of unit cells, wherein the metal grid layer and the printed circuit board layer are aligned to reside in a substantially common footprint in the longitudinal direction and stacked in a front-to-back direction of the base station antenna.

3. The base station antenna of claim 2, wherein the metal grid layer resides in front of the printed circuit board layer.

4. (canceled)

5. The base station antenna of claim 1, wherein the supplemental FSS structure has a length, the primary reflector has a length and the first FSS has a length, all in the longitudinal direction of the base station antenna, wherein the length of at least one layer of the supplemental FSS is in a range of 10-30% of the length of the first FSS and/or the primary reflector.

6. (canceled)

7. The base station antenna of claim 1, wherein at least part of the supplemental FSS structure resides in front of a plane of the first FSS.

8. The base station antenna of claim 1, wherein the supplemental FSS structure comprises a metal grid layer with an array of unit cells that resides in a plane in front of a plane of the first FSS and has a longitudinal extent that resides only along a portion of the first FSS or is configured to not overlap with the first FSS.

9. The base station antenna of claim 8, wherein the base station antenna further comprises a feed board coupled to the metal grid layer, and wherein the feed board is configured to replicate at least part of a unit cell shape of a unit cell of the array of unit cells.

10. The base station antenna of claim 1, wherein the supplemental FSS structure comprises a metal grid layer comprising at least one feed board aperture and an array of unit cells, and wherein a feed board extends across and overlaps a portion of a plurality of unit cells of the array of unit cells that surround the feed board aperture.

11. (canceled)

12. The base station antenna of claim 1, further comprising a first linear array of first radiating elements and a second linear array of first radiating elements, wherein a single one of the first radiating elements of the first linear array of first radiating elements and a single one of the first radiating elements of the second linear array of radiating elements project forward from the supplemental FSS structure.

13. The base station antenna of claim 1, further comprising a plurality of columns of second radiating elements that are laterally spaced apart, wherein only two rows of each of the plurality of columns of second radiating elements project forward from the supplemental FSS structure.

14. The base station antenna of claim 1, further comprising a bracket that extends laterally between a pair of longitudinally extending rails, wherein the bracket is attached to a bottom portion of the supplemental FSS structure and to the primary reflector, wherein the bracket has a U-shape with the arms of the U-shape facing downward over the primary reflector.

15. (canceled)

16. The base station antenna of claim 2, wherein the metal grid layer comprises side walls that angle outward in a forward direction from a primary planar body thereof, and wherein the printed circuit board layer terminates laterally inward of the side walls of the metal grid layer.

17. The base station antenna of claim 16, wherein the side walls comprise an array of unit cells arranged in a repeating pattern along a length of the supplemental FSS structure.

18. The base station antenna of claim 2, wherein the array of unit cells of the metal grid layer is arranged in a first pattern that extends across at least a major portion of a lateral dimension of the base station antenna behind a first and second linear arrays of first radiating elements, behind multiple columns of second radiating elements and in front of a multiple-column array of third radiating elements.

19. The base station antenna of claim 1, wherein the supplemental FSS structure reflects and/or blocks energy in a first operating frequency band of a first radiating element of the base station antenna and in a second operating frequency band of a second radiating element of the base station antenna, wherein the second frequency band includes frequencies above the first frequency band, and the supplemental FSS structure allows energy from a mMIMO array of radiating elements in a third operating frequency band to propagate therethrough, wherein the third operating frequency band comprises frequencies above the second frequency band, and wherein at least some of the mMIMO array of radiating elements are positioned behind the supplemental FSS structure.

20. The base station antenna of claim 1, further comprising an active antenna unit positioned behind a rear of a housing enclosing the first FSS, the supplemental FSS structure and the primary reflector.

21. (canceled)

22. The base station antenna of claim 1, further comprising a plurality of feed boards coupled to the supplemental FSS structure, wherein at least some of the plurality of feed boards have a lattice body with apertures surrounded by linear segments defining at least first and second conductive signal traces, and wherein the first and second conductive signal traces extend downward over the primary reflector.

23-24. (canceled)

25. The base station antenna of claim 1, wherein the first FSS terminates above the supplemental FSS structure.

26. The base station antenna of claim 2, wherein the metal grid layer is configured to block and/or reflect RF energy from some radiating elements, and wherein the printed circuit board layer is configured to block and/or reflect RF energy from other radiating elements.

27-28. (canceled)

29. A base station antenna, comprising:
a reflector;
a first frequency selective surface (FSS);
an array of first frequency band radiating elements that are all coupled to a first radio frequency (RF) input, where a first subset of the first frequency band radiating elements overlap the reflector in a forward direction that is perpendicular to a plane defined by a major surface of the reflector and a second subset of the first frequency band radiating elements overlap the first FSS in the forward direction; and
a supplemental frequency selective surface (FSS) structure that overlaps the first FSS and at least one of the first frequency band radiating elements in the second subset of the first frequency band radiating elements in the forward direction but does not overlap all of the first frequency band radiating elements in the second subset of the first frequency band radiating elements in the forward direction.

30-33. (canceled)
